(19) United States
(12) Patent Application Publication
(10) Pub. No.: US 2011/0141327 A1
(43) Pub. Date: Jun. 16, 2011

(54) IMAGE CAPTURING SYSTEM

(75) Inventors: CHARLES CHEN, Taipei County (TW); CHUNG-KWANG CHEN, Taipei (TW)

(73) Assignee: CC&C TECHNOLOGIES, INC., Jhonghe City (TW)

(21) Appl. No.: 12/833,013

(22) Filed: Jul. 9, 2010

Related U.S. Application Data
(60) Provisional application No. 61/285,551, filed on Dec. 11, 2009.

(51) Int. Cl. H04N 5/335; H04N 5/225

(52) U.S. Cl. 348/294; 348/374; 348/E05.091; 348/E05.024

(57) ABSTRACT

The present invention discloses an image capturing system comprising a printed circuit board and an image capturing module. The image capturing module comprises a processing device, an image capturing device, a lens and a housing. The processing device is disposed above the printed circuit board and electronically connected with the printed circuit board. The image capturing device is disposed above the processing device and electronically connected with the processing device. The lens is disposed above the image capturing device, and the housing is disposed on the printed circuit board and encloses the processing device, the image capturing device and the lens.

### FIELD

The exemplary embodiment(s) of the present invention relates to a field of image capturing system. More specifically, the exemplary embodiment(s) of the present invention relates to an image capturing system that integrates a processing device and an image capturing device into a housing.

### BACKGROUND

Please refer to FIG. 1A, in which the conventional image capturing system 1 comprises a lens 112, housing 113, a complementary metal-oxide semiconductor (CMOS) sensor 111, a digital signal processor (DSP) 110, an interface (USB, I2C, SPI, UART, or Wire Serial Bus) 16 and a printed circuit board (PCB) 10. The housing 113, the COMS sensor 111, the DSP 110 and the interface 16 are disposed on the PCB 10. However, the DSP 110 and the interface 16 occupy lots of space of the image capturing system 1, and there's no such design capable of integrating the aforementioned devices.

Please refer to FIG. 1B, which another type of conventional image capturing system 1. The difference between FIG. 1A and FIG. 1B is that the DSP and the interface are integrated into one single processing device 110. However, this kind of layout still occupies lots of space of the image capturing system 1.

Therefore, providing a size-reduced image capturing system that integrates the COMS sensor, the DSP and the interface and disposes the aforesaid devices into the housing and under a lens is required.

### SUMMARY

To solve the problems in the conventional arts, it is a primary object of the present invention to provide an image capturing system to solve the problem that the DSP and the interface occupy too much space of the image capturing system.

To achieve the above object, an image capturing system according to the present invention is disclosed, which comprises a printed circuit board and an image capturing module. The image capturing module comprises a processing device, an image capturing device, a lens and a housing. The processing device is disposed above the printed circuit board and electronically connected thereto. The image capturing device is disposed above the processing device and electronically connected thereto. The lens is disposed above the image capturing device, and the housing is disposed on the printed circuit board, encloses the processing device and the image capturing device, and holds and secures the lens.

Wherein the image capturing system further comprises an output interface integrated into the processing device.

Wherein a first screw thread is disposed on the outer surface of the housing, and a casing having a second screw thread disposed on the inside surface thereof is arranged on the printed circuit board, and the housing is disposed in the casing with the first screw thread meshing the second screw thread.

Wherein a knob is disposed around the outer surface of the upper part of the housing, so the housing could be moved upward or downward relatively to the casing by turning the knob clockwise or counterclockwise, and the focus of the lens could be adjusted to meet the image capturing device.

Wherein the image capturing device and the processing device is covered by a transparent package layer.

Wherein the image capturing device is a charge coupled device (CCD) or a complementary metal-oxide semiconductor (CMOS) sensor, and the processing device is a digital signal processor (DSP), and the printed circuit board is a hard printed circuit board or a flexible printed circuit board.

To achieve the above object, another image capturing system according to the present invention is disclosed, which comprises a printed circuit board and an image capturing module. The image capturing module comprises a processing device, an image capturing device, a lens and a housing. The processing device is disposed above the printed circuit board and electronically connected with the printed circuit board. The processing device is disposed around the image capturing device, and the image capturing device is electronically connected with the processing device and the printed circuit board. The lens is disposed above the image capturing device and the processing device. The housing is disposed on the printed circuit board, enclosing the processing device and the image capturing device, and holding and securing the lens.

Wherein the image capturing system further comprises an output interface integrated into the processing device.

Wherein a first screw thread is disposed on the outer surface of the housing, and a casing having a second screw thread disposed on the inside surface thereof is arranged on the printed circuit board, and the housing is disposed in the casing with the first screw thread meshing the second screw thread.

Wherein a knob is disposed around the outer surface of the upper part of the housing, so the housing could be moved upward or downward relatively to the casing by turning the knob clockwise or counterclockwise, and the focus of the lens could be adjusted to meet the image capturing device.

Wherein the image capturing device and the processing device is covered by a transparent package layer.

Wherein the image capturing device is a charge coupled device (CCD) or a complementary metal-oxide semiconductor (CMOS) sensor, and the processing device is a digital signal processor (DSP), and the printed circuit board is a hard printed circuit board or a flexible printed circuit board.

To achieve the above object, still another image capturing system according to the present invention is disclosed, which comprises a printed circuit board and an image capturing module. The image capturing module comprises an integrated device, a lens and a housing. The integrated device is disposed on the printed circuit board and having an image capturing unit and a processing unit. The integrated device is electronically connected with the printed circuit board. The lens is disposed above the integrated device, and the housing is disposed on the printed circuit board and enclosing the integrated device, and holding and securing the lens.

Wherein the image capturing system further comprises an output interface integrated into the integrated device.

Wherein a first screw thread is disposed on the outer surface of the housing, and a casing having a second screw thread disposed on the inside surface thereof is arranged on the printed circuit board, and the housing is disposed in the casing with the first screw thread meshing the second screw thread.

Wherein a knob is disposed around the outer surface of the upper part of the housing, so the housing could be moved upward or downward relatively to the casing by turning the knob clockwise or counterclockwise, and the focus of the lens could be adjusted to meet the image capturing device.

Wherein the integrated device is covered by a transparent package layer.

Wherein the image capturing unit is a charge coupled device (CCD) or a complementary metal-oxide semiconductor (CMOS) sensor, and the processing unit is a digital signal processor (DSP), and the printed circuit board is a hard printed circuit board or a flexible printed circuit board.

With the above arrangements, the image capturing system according to the present invention has one or more of the following advantages:

(1) The size of the layout of the image capturing system could be reduced so as to further shrink the size of the electronic apparatus having the image capturing system.

(2) The manufacturing cost of the image capturing system could be further decreased by integrating the devices aforementioned into one device.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation, and understanding only.

FIG. 1A is a schematic diagram of a conventional image capturing system;

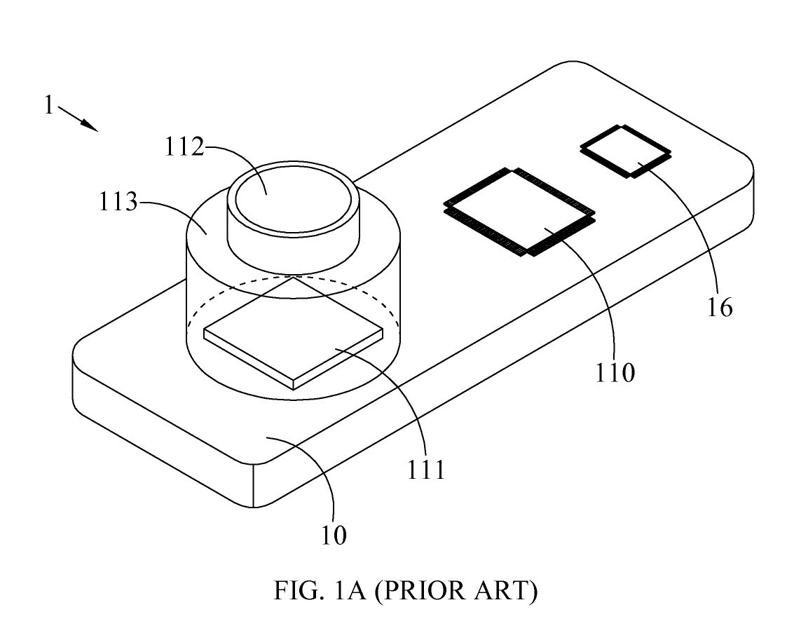

FIG. 1B is a schematic diagram of another conventional image capturing system;

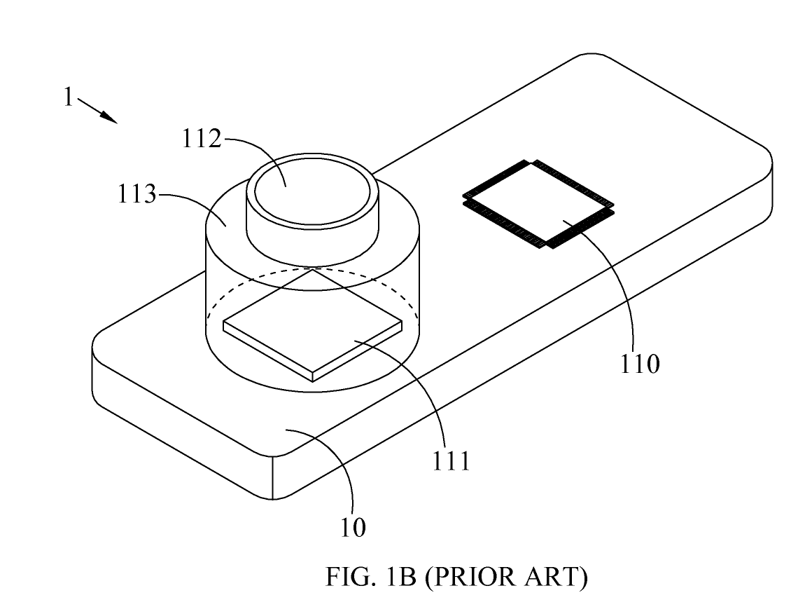

FIG. 2 is a schematic diagram of the first embodiment of the image capturing system in accordance to the present invention;

FIG. 3A is the first schematic diagram of the second embodiment of the image-capturing system in accordance to the present invention;

FIG. 3B is the second schematic diagram of the second embodiment of the image capturing system in accordance to the present invention;

FIG. 3C is the third schematic diagram of the second embodiment of the image capturing system in accordance to the present invention; and

FIG. 4 is the schematic diagram of the third embodiment of the image capturing system in accordance to the present invention.

### DETAILED DESCRIPTION

Exemplary embodiments of the present invention are described herein in the context of an image capturing system.

Those of ordinary skilled in the art will realize that the following detailed description of the exemplary embodiment(s) illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

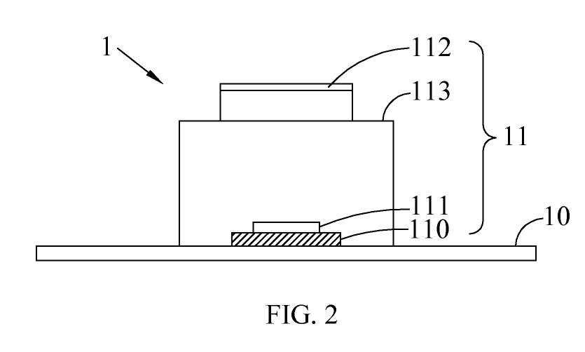

Please refer to FIG. 2, which is a schematic diagram of the first embodiment of the image capturing system in accordance to the present invention. As shown in this figure, the image capturing system 1 according to the present invention comprises a printed circuit board (PCB) 10 and an image capturing module 11. The image capturing module 11 comprises a processing device 110, an image capturing device 111, a lens 112 and a housing 113. The processing device 110 is disposed above the printed circuit board 10 and electronically connected with the printed circuit board 10. The image capturing device 111 is disposed above the processing device 110 and electronically connected with the processing device 110. The lens 112 is disposed above the image capturing device 111, and the housing 113 is disposed on the printed circuit board 10, encloses the processing device 110 and the image capturing device 111, and holds and secures the lens 112.

In this embodiment, the image capturing system 1 further comprises an output interface (not shown in the figure) integrated into the processing device 110, thus the processing device 110 could communicate outward through the output interface. In addition, in some preferred embodiments, the image capturing device 111 could be a charge coupled device (CCD) or a complementary metal-oxide semiconductor (CMOS) sensor, and the processing device 110 could beta digital signal processor (DSP), and the printed circuit board 10 could be a hard printed circuit board or a flexible printed circuit board.

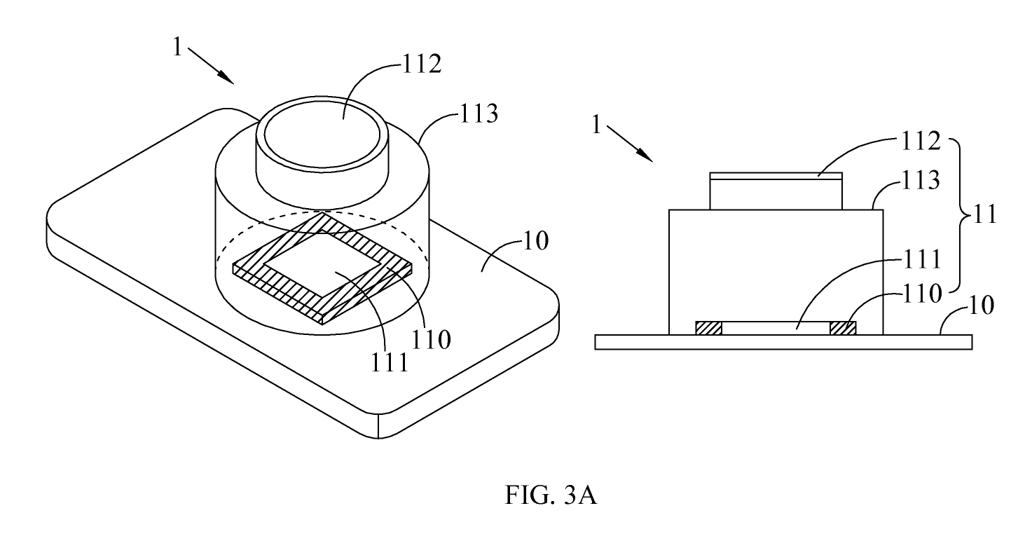

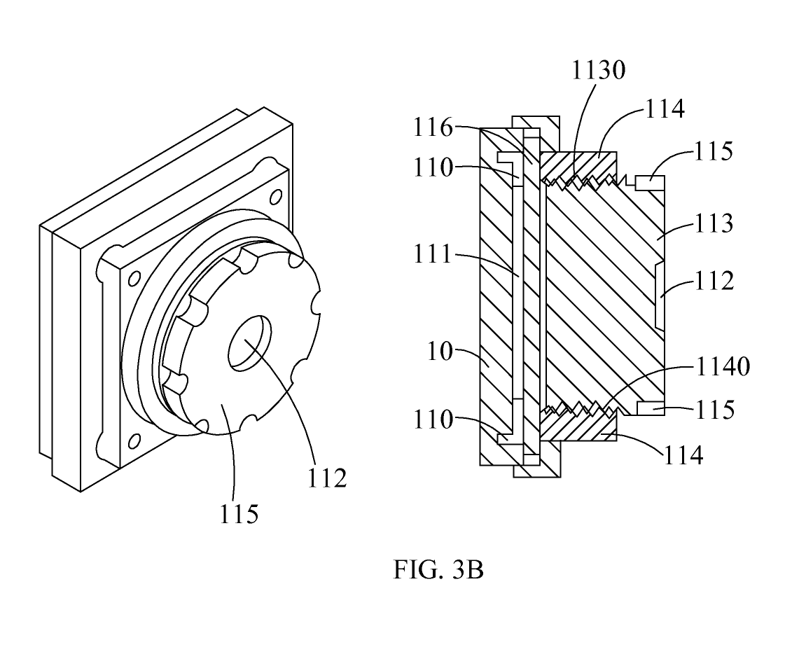

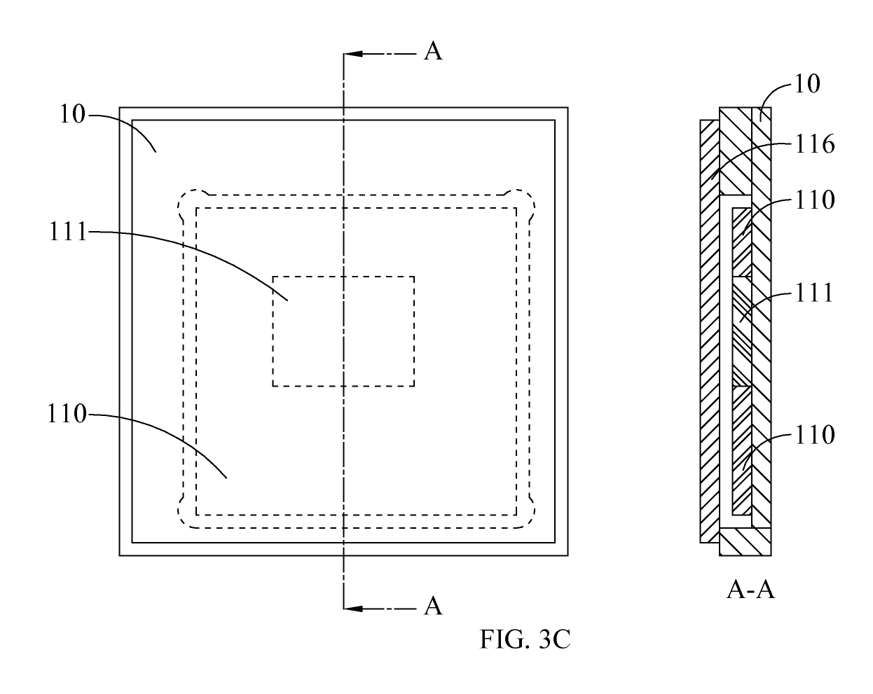

Please refer to FIG. 3A, which is the first schematic diagram of the second embodiment of the image capturing system in accordance to the present invention. As shown in this figure, the difference between the second embodiment and the first embodiment is that the processing device 110 is disposed around the image capturing device 111 (also refer to FIG. 3C) and electronically connected with the image capturing device 111 and the printed circuit board 10.

Please refer to FIGS. 3B and 3C, which are the second and third schematic diagrams of the second embodiment of the image capturing system in accordance to the present invention. As shown in FIG. 3B, a first-screw thread 1130 is disposed on the outer surface of the housing 113, and a casing 114 having a second screw thread 1140 disposed on the inside surface thereof is arranged on the printed circuit board 10, and the housing 113 is disposed in the casing 114 with the first screw thread 1130 meshing the second screw thread 1140. In addition, a knob 115 is disposed around the outer surface of the upper part of the housing 113, so the housing 113 could be moved upward or downward relatively to the casing 114 by turning the knob 115 clockwise or counterclockwise, and the focus of the lens 112 could be adjusted to meet the image capturing device 111. Furthermore, the image capturing device 111 and the processing device 110 could be covered by a transparent package layer 116, and the transparent package layer 116 could protect the image capturing device 111 and the processing device 110 from moisture. Still, the image capturing system 1 could further comprises an output interface (not shown in the figures) integrated into the processing device 110, so the processing device 110 could communicate outward through the output interface.

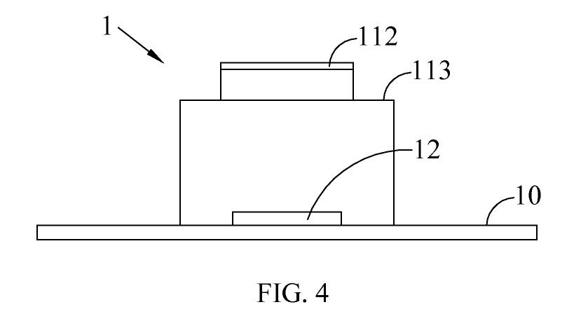

Please refer to FIG. 4, which is the schematic diagram of the third embodiment of the image capturing system in accordance to the present invention. As shown in this figure, the difference between the third embodiment and the first and second embodiment is that the image capturing device 111 and the processing device 110 shown in the first and second embodiment, and even the output interface are integrated in an integrated device 12, and the integrated device 12 thus has a processing unit, a image capturing unit and a output interface unit (not shown in the figure) to process the signals, receive the light then generate signals correspondingly and communicate outward respectively, and the size of the layout of the image capturing system 1 could be further decreased. The other parts of this embodiment are same with the first and second embodiment, so it will not be described here again.

The present invention could reduce the size of the layout of the conventional image capturing system so as to further shrink the size of the electronic apparatus having the image capturing system, and the manufacturing cost of the image capturing system or the electronic apparatus having the image capturing system could be further decreased by integrating the all the electronic devices aforementioned into one device.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. An image capturing system, comprising:
a printed circuit board; and
an image capturing module, comprising:
a processing device disposed above the printed circuit board, and being electronically connected with the printed circuit board;
an image capturing device disposed above the processing device, and being electronically connected with the processing device;
a lens disposed above the image capturing device; and
a housing disposed on the printed circuit board, enclosing the processing device and the image capturing device, and holding and securing the lens.

2. The image capturing system of claim 1, wherein the image capturing system further comprises an output interface integrated into the processing device.

3. The image capturing system of claim 1, wherein a first screw thread is disposed on the outer surface of the housing, and a casing having a second screw thread disposed on the inside surface thereof is arranged on the printed circuit board, and the housing is disposed in the casing with the first screw thread meshing the second screw thread.

4. The image capturing system of claim 3, wherein a knob is disposed around the outer surface of the upper part of the housing, so the housing could be moved upward or downward relatively to the casing by turning the knob clockwise or counterclockwise, and the focus of the lens could be adjusted to meet the image capturing device.

5. The image capturing system of claim 1, wherein the image capturing device and the processing device is covered by a transparent package layer.

6. The image capturing system of claim 1, wherein the image capturing device is a charge coupled device (CCD) or a complementary metal-oxide semiconductor (CMOS) sensor, and the processing device is a digital signal processor (DSP), and the printed circuit board is a hard printed circuit board or a flexible printed circuit board.

7. An image capturing system, comprising:
a printed circuit board; and
an image capturing module, comprising:
a processing device disposed above the printed circuit board, and being electronically connected with the printed circuit board;
an image capturing device surrounded by the processing device being disposed on the printed circuit board, and the image capturing device being electronically connected with the processing device and the printed circuit board;
a lens disposed above the image capturing device and the processing device; and
a housing disposed on the printed circuit board, enclosing the processing device and the image capturing device, and holding and securing the lens.

8. The image capturing system of claim 7, wherein the image capturing system further comprises an output interface integrated into the processing device.

9. The image capturing system of claim 7, wherein a first screw thread is disposed on the outer surface of the housing, and a casing having a second screw thread disposed on the inside surface thereof is arranged on the printed circuit board, and the housing is disposed in the casing with the first screw thread meshing the second screw thread.

10. The image capturing system of claim 9, wherein a knob is disposed around the outer surface of the upper part of the housing, so the housing could be moved upward or downward relatively to the casing by turning the knob clockwise or counterclockwise, and the focus of the lens could be adjusted to meet the image capturing device.

11. The image capturing system of claim 7, wherein the image capturing device and the processing device is covered by a transparent package layer.

12. The image capturing system of claim 7, wherein the image capturing device is a charge coupled device (CCD) or a complementary metal-oxide semiconductor (CMOS) sensor, and the processing device is a digital signal processor (DSP), and the printed circuit board is a hard printed circuit board or a flexible printed circuit board.

13. An image capturing system, comprising:
a printed circuit board; and
an image capturing module, comprising:
an integrated device having an image capturing unit and a processing unit disposed on the printed circuit board, and the integrated device being electronically connected with the printed circuit board;
a lens disposed above the integrated device; and
a housing disposed on the printed circuit board enclosing the integrated device and the lens.

14. The image capturing system of claim 13, wherein the image capturing system further comprises an output interface integrated into the integrated device.

15. The image capturing system of claim 13, wherein a first screw thread is disposed on the outer surface of the housing, and a casing having a second screw thread disposed on the inside surface thereof is arranged on the printed circuit board, and the housing is disposed in the casing with the first screw thread meshing the second screw thread.

16. The image capturing system of claim 15, wherein a knob is disposed around the outer surface of the upper part of the housing, so the housing could be moved upward or downward relatively to the casing by turning the knob clockwise or counterclockwise, and the focus of the lens could be adjusted to meet the image capturing device.

17. The image capturing system of claim 13, wherein the integrated device is covered by a transparent package layer.

18. The image capturing system of claim 13, wherein the image capturing unit is a charge coupled device (CCD) or a complementary metal-oxide semiconductor (CMOS) sensor, and the processing unit is a digital signal processor (DSP), and the printed circuit board is a hard printed circuit board or a flexible printed circuit board.
